(19) United States
(12) Patent Application Publication
(10) Pub. No.: US 2004/0110542 A1
(43) Pub. Date: Jun. 10, 2004

(54) Backup power supply for portable telephone

(76) Inventor: Kazunari Shozen, Tokyo (JP)

Correspondence Address: NIXON & VANDERHYE, PC, 1100 N GLEBE ROAD, 8TH FLOOR, ARLINGTON, VA, 22201-4714, US

(21) Appl. No.: 10/442,068

(22) Filed: May 21, 2003

(30) Foreign Application Priority Data
Dec. 6, 2002 (JP) 2002-354903

(51) Int. Cl. H04M 1/00

(52) U.S. Cl. 455/572; 455/575.1

(57) ABSTRACT

A backup power supply is detachably connected with a portable telephone and has a power-feed circuit, which includes at least four batteries and which is capable of supplying power. At least one of the batteries is disconnectable. When the at least one disconnectable battery is disconnected, the remaining batteries are capable of forming a power-feed circuit to supply power.

### BACKGROUND OF THE INVENTION

1. Field of the Invention

The present invention relates to a backup power supply that is used when a portable telephone becomes unusable due to a voltage drop of its built-in power supply, i.e., a decrease in battery capacity, during use of the portable telephone, and that is detachably connected with the portable telephone. More specifically, the present invention relates to a detachable backup power supply that is used for portable telephones requiring different feed voltages.

2. Description of the Related Art

Conventionally, lithium-ion batteries are widely used as built-in power supplies for portable telephones. When a voltage drop occurs after a certain period of use, the built-in batteries can be recharged for repeated use and can last for a long period of time.

Since portable telephones are frequently used while away from the home or office, backup power supplies, which include alkali batteries or manganese batteries and which have terminals connectable with a portable telephone, are available as temporary power supplies at low prices at many stores. Thus, when a voltage drop of a built-in lithium-ion battery occurs while the user is away from the home or office, he or she can use the portable telephone by purchasing such a backup power supply and connecting it with the portable telephone to supply a voltage therefrom.

For example, backup power supplies using multiple AA batteries or a rectangular battery are widely used as backup power supplies for portable telephones.

Since batteries for conventional portable telephones having black-and-white liquid-crystal displays require voltages of about 3.5 to 4.5 V, backup power supplies for the portable telephones are adapted so as to correspond to those voltages. Such backup power supplies, however, have a problem in that they can only be used for a very short talk time.

For presently-popular portable telephones, for example, those having a large and color liquid-crystal display screen that requires a large amount of power consumption, the backup power supplies can last for several minutes for such portable telephones at the longest and thus cannot fully serve the purpose as backup power supplies.

Even with a rectangular battery, it can last only for a short period of time due to its low electrical capacity.

In contrast, Japanese Unexamined Patent Application Publication No. 2002-27680, filed by the present applicant, proposes a temporary power supply that can last for a long period for presently-popular portable telephones requiring a large amount of power consumption and having many added features, including a large and color liquid display screen.

The temporary power supply for portable telephones has a power-feed circuit including four or more AA alkaline batteries as a power source.

This temporary power supply can be used for quite a long time. The temporary power supply can also provide a back current protection and can supply a stable voltage by using, for example, a regulator and a diode.

However, since feed voltages for portable telephones vary depending on the types and features thereof, it has been difficult to use one backup power supply to feed voltages that suit all types of portable telephones in a general purpose manner.

In general, a protection feature or a capacity provided in a portable telephone allows the portable telephone to tolerate a slight difference between the feed voltage of the backup power supply for the portable telephone and the operating voltage of the portable telephone. A large difference, however, can put an intolerable burden on the portable telephone, which is likely to lead to failure, heat generation, or the like, and even can render the backup power supply unusable for the portable telephone.

The user may not be able to use a portable telephone if he or she fails to select a backup power supply that fits therefor. Thus, it is desired to provide a single backup power supply that is suitably used for various types of portable telephones.

In view of the foregoing, Publication No. 2002-27680 described above also proposes a temporary power supply that has a switch and that can supply two types of feed voltage by switching the switch to a power-feed circuit having a resistance.

The above temporary power supply uses, for example, four AA batteries and produces a feed voltage of 6 V. The temporary power supply can also supply a stable voltage using, for example, a diode and a regulator, and can provide two types of regulated feed voltage.

The temporary power supply, however, requires a certain degree of use of a resistance in the circuit, and thus has a risk of being heated.

In addition, four AA batteries must always be used, which is not economically advantageous.

Additionally, typical AC adapters for charging batteries use feed voltages of about 4.2 to 5.8 V. Thus, it is desired to be able to supply at least two types of voltage which match the feed voltages.

It is also desired to provide a backup power supply for portable telephones which is structurally miniaturized and which can easily be manufactured at a low cost.

Accordingly, there has been a need for some solution to the various requirements.

### SUMMARY OF THE INVENTION

According to the present invention, there is provided a backup power supply that is detachably connected with a portable telephone. The backup power supply has a power-feed circuit. The power-supply circuit includes at least four batteries to allow power supply, and at least one of the batteries is disconnectable. When the at least one disconnectable battery is disconnected, the remaining batteries are capable of forming a power-feed circuit to supply power.

This arrangement offers a first advantage in that batteries can be effectively utilized and multiple types of voltage can be supplied from one backup power supply.

In particular, adapters for presently-available portable telephones employ feed voltages of about 4.2 to 5.8 V. Thus, the use of four batteries, one of which being disconnectable, as a power source for the backup power supply of the present invention allows the supply of voltages of, in theory, 4.5 and 6 V, which are the most suitable for those portable telephones.

In addition, when a feed voltage for portable telephones is increased in the future, changing the number of batteries allows for the use of the backup power supply and setting an appropriate number of batteries that can be disconnected allows the supply of required voltages that are switched. Further, setting a plurality of batteries to be disconnectable allows a single backup power supply to supply a plurality of types of voltages to portable telephones. This arrangement, therefore, offers a second advantage in that the backup power supply of the present invention can be easily manufactured and can be used in a variety of applications.

Rather than using a resistance or the like that causes heat generation, the battery disconnection is achieved by switching power-feed circuits including batteries in the present invention. This arrangement, therefore, offers a third advantage in that the safety of the backup power supply is enhanced.

Preferably, the backup power supply further includes a switch for disconnecting the at least one disconnectable battery included in the power-feed circuit.

Preferably, the backup power supply further includes a casing and an operation portion for the switch. The operation portion is provided at a surface of the casing to allow the switch to be manually switched.

Since the operation portion for the switch is provided at a surface of the casing, the battery disconnection is made possible by manually switching the operation portion. This arrangement, therefore, offers a fourth advantage in that the usability of the backup power supply for a portable telephone can be enhanced.

Preferably, the backup power supply includes a casing in which the batteries are provided. The switch includes terminal-engaging portions that are connected to the power-feed circuit and that allow a voltage to be supplied when being in contact with opposing ends of the batteries. When the at least one disconnectable battery is received by at least one of the terminal-engaging portions which is connected to the at least one disconnectable battery, the at least one of the terminal-engaging portions is displaced so as to be electrically connected to the power-feed circuit, thereby allowing voltage supply. When the at least one disconnectable battery at the terminal-engaging portion is removed, the terminal-engaging portion is displaced so as to be electrically disconnected from the power-feed circuit. This arrangement, therefore, offers a fifth advantage in that feed voltages can be easily adjusted through switching by mounting or removing the battery.

The power-feed circuit may include first and second power-feed circuits and first and second diodes provided between the first and second power-feed circuits. The second power-feed circuit includes the at least one disconnectable battery and the first power-feed circuit includes the other batteries. When the at least one disconnectable battery in the second power-feed circuit is removed, the first diode allows power to be supplied from the first power-feed circuit. When the at least one disconnectable battery is mounted in the second power-feed circuit, the second diode allows power to be supplied from the first power-feed circuit and the second power-feed circuit.

This arrangement offers a sixth advantage in that a voltage can be supplied, by controlling the flow of electrical current using the diode, from either or both of the power-feed circuits that include necessary batteries.

The batteries may be constituted by AA batteries or AAA batteries.

### BRIEF DESCRIPTION OF THE DRAWINGS

FIG. 1 is a circuit diagram of a power-feed circuit in a backup power supply, according to a first embodiment of the present invention, for portable telephones;

FIG. 2 is a circuit diagram of a power-feed circuit in a backup power supply, according to another embodiment of the present invention, for portable telephones; and

FIG. 3 is a circuit diagram of a power-feed circuit in a backup power supply, according to yet another embodiment of the present invention, for portable telephones.

### DESCRIPTION OF THE PREFERRED EMBODIMENTS

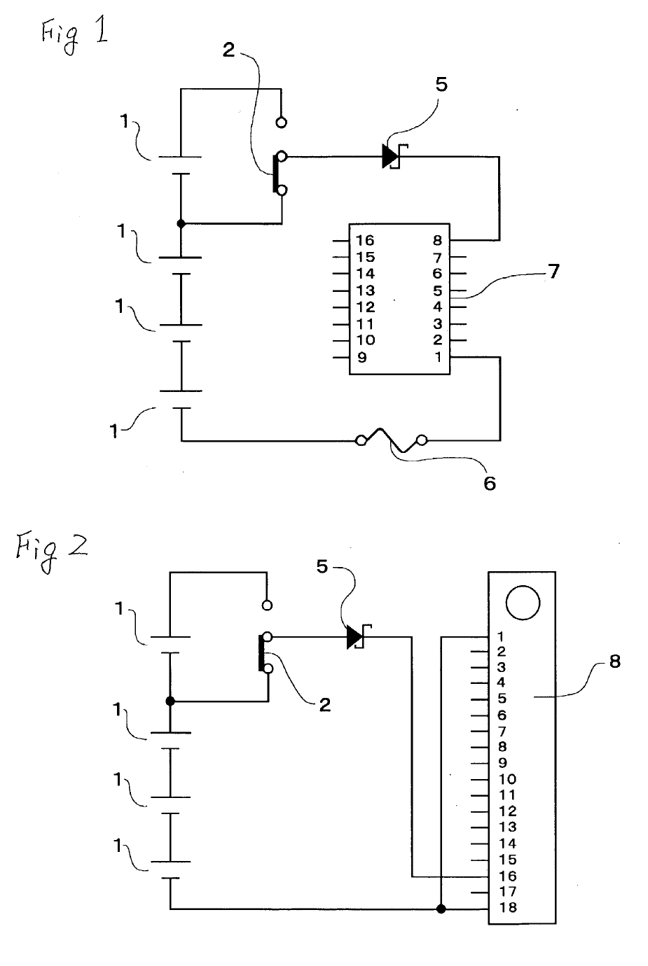

An embodiment of the present invention will now be described with reference to FIG. 1. FIG. 1 is a circuit diagram of a power-feed circuit that includes four series-connected AA batteries 1, one of which can be disconnected therefrom by a switch 2, to produce a total voltage of 6 V.

Switching of the switch 2 can provide a state in which the four AA batteries 1 are connected in series to allow power feeding and a state in which one of the batteries 1 is disconnected and the other three batteries 1 allow power feeding.

The power-feed circuit also has a fuse 6 and a diode 5, which provide overcurrent protection and back current protection.

Further, the power-feed circuit has a connector 7, which provides a detachable connection with a portable telephone.

Thus, in essence, with the four AA batteries 1 connected in series, the power-feed circuit can supply a voltage of about 6 V, and with the three AA batteries 1, the power-feed circuit can supply a voltage of about 4.5 V.

AC adapters for charging presently-popular portable telephones typically supply voltages of 4.2 to 5.8 V, and can supply the most appropriate voltages to individual portable telephones.

In particular, for a portable telephone that requires a feed voltage of about 4.5 V, it is sufficient to use only three AA batteries and thus not necessary to use four AA batteries.

Thus, it is sufficient to have a backup power supply including the number of batteries that is the most suitable for an individual portable telephone.

Thus, with such a backup power supply according to the present invention, the user can conveniently use it for a portable telephone that requires either of the feed voltages and also can use the number of batteries therefor as needed.

While FIG. 1 illustrates a basic configuration including four AA batteries with one of which being disconnectable, the present invention is not limited thereto. For example, a basic configuration which includes five AA batteries in total, with one or two of which being disconnectable, may also be employed.

While feed voltages which are most commonly used for charging portable telephones are from 4.2 to 5.8 V at present, required voltages may increase further in the future. At the same time, however, batteries which can be charged at a low voltage are expected to put into practice. To meet those requirements, the backup power supply of the present invention includes a plurality of, for example, AA batteries with at least one of which being disconnectable therefrom.

Additionally, for example, a basic configuration including five AA batteries with two of which being individually disconnectable in two stages may be employed to allow for three types of voltage supply using five, four, or three batteries.

Naturally, a basic configuration including four batteries may be employed to allow for three types of voltage supply using four, three, or two batteries.

That is, the present invention is applicable to a configuration that includes a plurality of batteries with one or more of which being disconnectable to allow for two or more types of voltage supply.

As well as alkaline batteries, the batteries may be of any types of manganese batteries, alkaline-manganese batteries, nickel batteries, nickel-manganese batteries, or the like.

That is, the batteries may be of any type that allow a plurality of batteries to be connected in series for use and that allow at least one of which to be disconnected.

While AA batteries are illustrated in FIG. 1, the present invention is not limited thereto and thus the batteries may be, for example, AAA batteries or C batteries which are different in size or storage capacity from AA batteries.

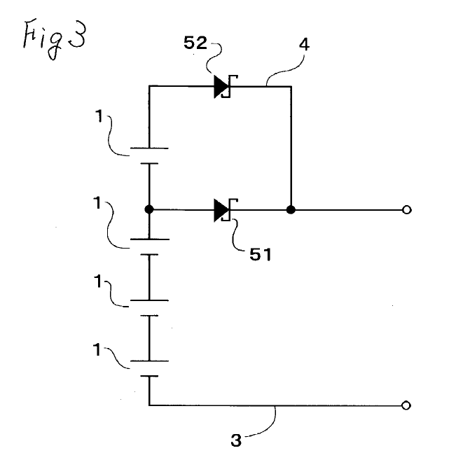

While the power-feed circuit in the circuit diagram shown in FIG. 1 has the connector 7, a power-feed circuit according to another embodiment having a connector 8 of another type, which is widely used at present, is shown in the circuit diagram of FIG. 2.

The basic configuration of the power-feed circuit in FIG. 2 is the same as that in FIG. 1, and the disconnection of one battery 1 is made possible by the switch 2.

For example, selecting a necessary connector so as to correspond to the shape of connection portion of a portable telephone used allows the backup power supply to be appropriately connected with the portable telephone.

While the power-feed circuit in FIG. 2 has no fuse, it may alternatively have a fuse in the present invention, as in FIG. 1.

Further, with regard to the switch 2, for example, an operation portion therefor may be exposed at the surface of a casing to allow for manual switching, thereby improving usability.

A known switching device may be used for the configuration of the switch 2 and the operation portion.

The switch 2 may be configured such that it can be manually switched as described above or can be switched, for example, by mounting or removing a battery.

In the latter case, the switching function may be realized by a structure of terminal-engaging portions that are provided at the casing and that are brought in contract with the terminals of batteries when the batteries are mounted.

For example, the backup power supply may have a switch that is realized such that at least one of the terminal-engaging portions for the disconnectable battery elastically projects in the battery-mounted direction, and, when a battery is mounted, the terminal-engaging portion is displaced against the elastic projection. With this arrangement, in response to the displacement, the terminal-engaging portion and the power-feed circuit are electrically connected to allow the mounted batteries to form a power-supply circuit, thereby allowing voltage supply.

On the other hand, when the battery is removed, the elasticity being applied to the terminal-engaging portion causes the battery to be displaced, for example, in the battery-mounting direction so that the terminal-engaging portion closes a circuit constituted by the other mounted batteries for the power-feed circuit. With this arrangement, even when one battery is removed, the remaining batteries can supply power.

This allows the supply of two types of voltage by mounting or removing a battery and allows the supply of a voltage that is optimized for a portable telephone used.

As described above, the backup power supply, which is used for portable telephones, according to the present invention allows for a simple adjustment of voltage and eliminates the need for mounting an unnecessary battery. In addition, the backup power supply can be easily manufactured and is quite cost effective.

Additionally, the backup power supply of the present invention not only allows the use of a portable telephone for a long time, by using four AA batteries, but also can significantly facilitate its application to voltages needed by portable telephones available in the future.

FIG. 3 shows a circuit of a backup power supply that allows switching by mounting or removing a battery without using a switch, according to still another embodiment of the present invention.

Referring to FIG. 3, the backup power supply has a total of four batteries 1 that are arranged in series. The backup power supply has a first power-feed circuit 3 and a second power-feed circuit 4 which are connected, the first power-feed circuit 3 including three batteries 1 and the second power-feed circuit 4 including one battery 1. The backup power supply has diodes 51 and 52 between the first power-feed circuit 3 and the second power-feed circuit 4.

Thus, when the batteries 1 are mounted in only the first power-feed circuit 3 and no battery is mounted in the second power-feed circuit 4, the diode 51 allows electrical current to flow from the first power-feed circuit 3.

In addition, when the battery 1 is also mounted in the second power-feed circuit 4, the diode 52, which is provided on a line on which the four batteries in total are arranged in series, allows electrical current to flow.

That is, when the battery 1 is mounted in the second power-feed circuit 4, a total of four batteries 1 serve as a power source, and when no battery is mounted in the second power-feed circuit 4, the three batteries 1 in the first power-feed circuit serve as a power source.

With this arrangement, mounting a required number of batteries allows a desired voltage to be supplied.

What is claimed is:

1. A backup power supply which is detachably connected with a portable telephone, the backup power supply comprising:
a power-feed circuit, which includes at least four batteries and which is capable of supplying power, at least one of the batteries being disconnectable,
wherein, when the at least one disconnectable battery is disconnected, the remaining batteries are capable of forming a power-feed circuit to supply power.

2. The backup power supply according to claim 1, further comprising a switch for disconnecting the at least one disconnectable battery included in the power-feed circuit.

3. The backup power supply according to claim 2, further comprising a casing and an operation portion for the switch, wherein the operation portion is provided at a surface of the casing to allow the switch to be manually switched.

4. The backup power supply according to claim 2, further comprising a casing in which the batteries are provided, wherein the switch comprises terminal-engaging portions that are connected to the power-feed circuit and that allow a voltage to be supplied when being in contact with opposing ends of the batteries; and wherein, when the at least one disconnectable battery is received by at least one of the terminal-engaging portions which is connected to the at least one disconnectable battery, the at least one of the terminal-engaging portions is displaced so as to be electrically connected to the power-feed circuit, thereby allowing voltage supply, and when the at least one disconnectable battery at the terminal-engaging portion is removed, the terminal-engaging portion is displaced so as to be electrically disconnected from the power-feed circuit.

5. The backup power supply according to claim 1, wherein the power-feed circuit comprises:
a first power-feed circuit and a second power-feed circuit, the second power-feed circuit including the at least one disconnectable battery and the first power-feed circuit including the other batteries; and
first and second diodes which are provided between the first power-feed circuit and the second power-feed circuit,
wherein, when the at least one disconnectable battery in the second power-feed circuit is removed, the first diode allows power to be supplied from the first power-feed circuit, and when the at least one disconnectable battery is mounted in the second power-feed circuit, the second diode allows power to be supplied from the first power-feed circuit and the second power-feed circuit.

6. The backup power supply according to one of claims 1 to 5, wherein the batteries comprise AA batteries.

7. The backup power supply according to one of claims 1 to 5, wherein the batteries comprise AAA batteries.
